(19) United States
(12) Patent Application Publication
(10) Pub. No.: US 2012/0029958 A1
(43) Pub. Date: Feb. 2, 2012

(54) DEVICE AND METHOD FOR DYNAMICALLY ADAPTING A COMPLEX SYSTEM TO VARIOUS CONTEXTS OF USE OF THE COMPLEX SYSTEM

(75) Inventors: Dhouha AYED, Nanterre (FR); Aymen TROUDI, Palaiseau (FR)

(73) Assignees: CENTRE NATIONAL DE LA RECHERCHE SCIENTIFIQUE, Paris (FR); THALES, Neuilly-sur-Seine (FR)

(21) Appl. No.: 13/191,680

(22) Filed: Jul. 27, 2011

(30) Foreign Application Priority Data
Jul. 27, 2010 (FR) FR1003148

(51) Int. Cl. G06Q 10/00

(52) U.S. Cl. 705/7.11

(57) ABSTRACT

A device for dynamically adapting a complex system to various contexts of use of the complex system, by executing business processes adapted automatically by the said device to a current context, the device taking as input a variable business process model that can vary as a function of context.

The present invention relates to a device for dynamically adapting a complex system to various contexts of use of the said complex system. The invention applies notably to complex information systems based on a services-oriented architecture, implemented for example with the aid of Web services. Generally, the invention applies in the field of adaptable systems which are increasingly present in ambient or ubiquitous computing.

A complex system may be defined as a system composed of sub-systems which interact with one another and which may be in interaction with human users or other external systems. A complex system is generally used on a set of computers interconnected together by a computerized network. The concept of a computer has been profoundly modified with the upsurge in ambient computing; it henceforth includes numerous types of electronic objects which are:
intelligent, that is to say containing a built-in processor;
communicating;
scattered among an environment of users;
gathering or providing information which is relevant for themselves.

Complex systems comprise a large number of entities undertaking a great many interactions between them and taking into account a great deal of information to carry out a complex operation more or less automatically. The said information is not necessarily all known during the design of the system. Certain information may be unknown or unpredictable during the design of the system and therefore, it is not possible or partially possible for the system to take it into account during its operation. In both cases, this may lead to system behaviors which are unexpected, or indeed unforecastable for its user, as and when this information occurs and evolves over time. Such behaviors can have very negative consequences in human, social or economic terms.

The complex operations implemented by complex systems are generally critical for organizations using complex systems. Such operations rely increasingly on automatable business processes. Business processes make it possible notably to describe exchanges between the various sub-systems and the users of the complex system, and notably in terms of activities. The activities can have a given order and a given organizational aim. The business processes are generally tailored during the design of the system, by people having great experience and expertise in one or more business fields of appeal to the organization. Such business processes are increasingly often implemented by mobile terminals such as telephones or digital personal assistants. The technical characteristics of these terminals, such as their power, their memory capacity, can have an influence on the proper progress of the operations and therefore the processes. Other information on the users of these terminals, such as their skills, identities or locations, their physical environment such as meteorology, temperature or noise can also impact the proper progress of the operations and processes. Such information is called context information and forms a context. Generally, the context comprises any item of information describing the situation of the user, of the system and of his physical environment, that may have an impact on the behavior of the complex system.

The fields of application of complex systems are diverse. For example, in the field of telecommunications, they may be implemented to improve the quality of services provided, for example through management of the congestion of the telecommunication network and of the mobility of its users. Examples of context information for the telecommunications field may be: a bandwidth of the network or a position of these users. In the airport field, complex systems may be implemented within the framework of applications for managing crises by using information gathered notably by cameras, satellites or smoke detectors. Examples of contexts for the airport field may be: abandoned luggage, a rapidly increasing temperature of a building or suspicious activity of a passenger.

Context information may evolve rapidly and in an unforecastable manner. For crisis management for example, a context such as “suspicious luggage” may evolve into an “explosion” context, the increasing temperature may evolve into a “fire” context, the suspicious activity of a passenger may evolve into a terrorist attack. Such context information is very unpredictable both as regards its evolution and its impact on the behavior of the crisis management complex system. For example, a behavior of a complex system may be initially a first interaction, configuration or composition of sub-systems and services, a first resource which executes a first activity, or else a second activity to be executed at a given time. The impacts of changes of context on the behavior of the system are varied: they may result in a new interaction, configuration or composition of sub-systems and services, a change of the resource executing the activity, or else a replacement of one activity by another more urgent one. Proper crisis management requires fast understanding of the context of the crisis, anticipation of its impact on the behavior of the complex system and the implementation of appropriate means for managing the crisis by propagating its impact through the business and technical layers of the complex system.

Business processes make it possible to describe various behaviors of the complex system from a business point of view during its design. The architecture and the computerized code of the complex system make it possible to describe its behavior from a technical point of view during its execution. The amount and the order of occurrence of this context information may increase rapidly and become unmanageable and impossible to forecast during design of the system by modeling its business processes. The behaviors described at the business level might therefore not satisfy all the context information that may intervene during the operation of the complex system. The developers of complex systems such as these must update the architecture and the computerized code of the system so that the complex system builds in a new behavior. Such updates are generally expensive in terms of calculation time. Moreover, any delay in their implementation can have heavy consequences in the case of critical complex systems such as systems for managing crises. The realization and management of complex systems such as these may notably come up against the following problems:
complexity related to a combinatorial explosion of the possible configurations of the system as a function of the changes of context;
impossibility of managing the impact of a dynamic change of context on various business processes managed by the complex system;
impossibility of automatically echoing a dynamic change of context on business processes, on the architecture of the complex system as well as on the technical layers of a complex system.

A configuration of a system is a disposition or an arrangement of parts making up the system. A configuration is defined by a choice of options or of variants provided by the system. In the field of computerized networks, a configuration is a given topology of the network. In the field of business process engineering, a configuration is a business process constructed on the basis of a set of tasks participating or given.

An idea of the complexity to be managed may be given through a mathematical formula calculating a number of possible configurations of a complex system, composed of an integer number n of sub-systems as a function of a number m of changes of context:

$$m \times {\sum }_{p = 1}^{n} \frac{n !}{p ! \times ( n - p ) !} \qquad ( 1000 )$$

where m also represents a maximum integer number of items of contextual information, and p is an integer number varying from one to n.

Taking the example of an airport, several types of crises can occur in an airport such as: a fire, an explosion, a terrorist attack, a chemical attack. The management of such crises in an airport may involve several human systems and parties belonging to different organizations:
crisis management systems of a crisis cell such as decision aid systems, systems for sharing and exchanging data of crises, systems for scheduling useful resources in the case of a crisis or systems for managing sensors;
airport management systems: for example a control tower system or an ATFCM system, the acronym standing for the expression Air Traffic Flow and Capacity Management;
fire crew management systems;
hospital management systems;
police facility management systems;
and in certain cases: systems relating to media or to public or governmental authorities such as the ministry of defense or home office.

The number of different organizations intervening in a crisis, and the interactions between their systems, depend on the context, that is to say on the type of crisis, its magnitude, its risks and its evolution. The way in which the activities are carried out by the sub-systems and the human parties are also context-dependent. For example, a crisis cell calls upon hospitals only if injuries are sustained. The choice of one or more hospitals can also depend on certain information: for example proximity to the site of the crisis, road traffic, hospitals intake capacity, the number of people injured, the nature of the injuries. Moreover, a crisis evolving over time, the requirement of the complex system to interact with one or the other of the organizations may arise right from the start of the crisis or later. For example, a crisis cell may decide to involve the police if the crisis has a terrorist or criminal nature. Then, as a crisis evolves, more accurate information on its nature may be available. Or else, its evolution may give rise to increasingly significant damage requiring the intervention of organizations which did not need to be called upon at the start of the crisis.

A crisis management system must therefore be capable of taking account of dynamic variations of context and of adapting itself as a function of the current context, notably by connecting dynamically to external systems belonging to diverse organizations, for example:
by dynamically activating all the gas sensors belonging to different zones of the airport so as to track the evolution of a gas leak;
by modifying information displayed on the mobile terminals of first-aiders for security and network bandwidth reasons.

Generally, dynamic, that is to say during operation, adaptation of a crisis management system can have several forms such as:
passing dynamically from a first composition of sub-systems to a second composition of sub-systems;
deleting, adding or modifying dynamically an activity carried out by a sub-system or a human party;
modifying dynamically the sub-system or the human party carrying out an activity;
modifying dynamically an order of the activities to be executed;
executing dynamically several parallel activities in a sequential order in the case of non-availability of resources.

Various studies have been carried out into the adaptability of ubiquitous and ambient computerized systems.

First studies have focused mainly on environments making it possible to execute adaptable dynamic systems, allowing hot (that is to say during operation) connection and deployment of components. Some of these first studies define middleware, or “mediator software”, managing the adaptability of distributed applications. In the field of computerized architecture, middleware is an expression designating a layer of software which created an exchange network for swapping information between various computerized applications. The exchange network is implemented through the use of one and the same technique of information exchanges in all the applications involved with the aid of software components. Such “middleware” is notably proposed and developed within the framework of European projects such as MADAM described in “Distributed context management in a Mobility and ADaptation enAbling Middleware, ACM 2006” and MUSIC described in “MUSIC: Middleware Support for Self-Adaptation in Ubiquitous and Service-Oriented Environments, Springer 2009” or in other research studies such as Wcomp described in “A Middleware for Ubiquitous Computing: WComp, 2008”.

Other second studies have focused on approaches and environments for the design and development of adaptable dynamic systems. These second studies consist of a set of design methodologies and meta-models for the modeling of adaptable systems, as well as application “Frameworks” for the development of these systems. A model is an abstraction of a system which is sufficient for understanding the operation of the modeled system. A meta-model defines a language for expressing a model, that is to say modeling rules to be complied with in order to construct a model in conformity with its meta-model. A “Framework” is in a general manner a library of structural software components, which define foundations as well as the organization of all or of a part of a piece of software, that is to say its architecture. These second types of studies are described notably by Floch, J., Hallsteinsen, S., Stay, E., Eliassen, F., Lund, K., and Gjorven E., in “Using architecture models for runtime adaptability in Software IEEE, 23(2):62-70, 2006” and by Brice Morin, Franck Fleurey, Nelly Bencomo, Jean-Marc Jézéquel, Arnor Solberg, Vegard Dehlen and Gordon Blair in “An Aspect-Oriented and Model-Driven Approach for Managing Dynamic Variability, MoDELS 2008”.

The studies cited above often come within the framework of component-based approaches and/or middleware and are focused on adaptations carried out at the system architecture level and at the system programming code level. The impact of a variability at the architectural level of a system results in variations of the components constituting the systems and connections between the components. Variability is by definition a capacity of a software artifact to be customized or configured. A software artifact is for example a port or a software component. The introduction of variability at the component level and at the component assembly level makes it possible to facilitate possible reconfigurations of the complex system and therefore its adaptation to the various changes. However, none of the various existing approaches makes it possible to investigate the impact of changes of context on the business aspects of the complex system, nor to transfer an impact of the changes of context to the architecture and the computerized code of the complex system. The business aspects of a complex system are defined by business experts of a particular field and describe conceptually collaborations and interactions between sub-systems within one or more organizations. The architectures thus proposed are focused on an architectural and technical adaptation of the complex system with no correlation with business adaptations. The two levels, business and technical, are then out of phase with regard to the context-dependent adaptation aspects.

Other third studies which are concerned with the business aspects, introduce a variability in the business processes so as to increase their capacity to self-configure and to self-adapt as a function of an organization's requirements. These studies are described by M. Rosemann and W. M. P. van der Aalst in “A Configurable Reference Modelling Language, 2007”, by M. Razavian and R. Khosravi in “Modeling Variability in Business Process Models Using UML, 2008” and by M. La Rosa, M. Dumas, A. H. M. ter Hofstede and J. Mendling in “Managing Variability in Process-Aware Information Systems, 2009”

On the one hand, these third studies remain focused on the phase of design and modeling of business processes, without intending to execute a concrete complex system based on these processes. And on the other hand, the variability introduced by these studies is a variability that is experienced in the business field, and which is conventionally dealt with by the approaches of products lines, and not a context-dependent dynamic variability. These studies are not aimed at dynamic adaptation of a complex system as a function of context taking at the same time the two aspects, business and technical.

Certain fourth studies formulated on cases of industrial investigations internal to Thales (for example a maritime supervision system) or in industrial search projects (for example the IsyCri project in “interopérabilité par mediation dans le cadre d'une dynamique de collaboration: application à la gestion de crise [interoperability by mediation within the framework of collaboration dynamics: application to crisis management], 2009”) use the notion of the context in the two phases of design of business processes and in the phase of executing these business processes based on the architecture and the technical code. These studies model the context as a business information item in their business processes, this being contrary to the very nature of the dynamically evolving context information. The business information items are generally countable and their order of receipt is known. Though it is impossible to forecast either the times at which the context events are received, or their order of appearance. Junctions, also called branchings, provided by business process modeling languages make it possible to conduct tests on countable business information items received in a forecast and known order, in contrast to unforecastable context information. These fourth studies are not concerned with context-dependent dynamic adaptation but with interoperability between sub-systems of a complex system.

Representing the variability and the possible configurations of a complex system as a function of context in business processes in the same manner as that described in the fourth studies, that is to say with business junctions, rapidly comes up against on the one hand the complexity of the resulting business processes and on the other hand the combinatorial explosion of possible configurations. By way of example, a business analyst who needs to represent a business process composed of four tasks executed sequentially and in all the possible orders with the possibility that one or more tasks are optional in certain contexts, is forced to represent the business process sixty-four times in the various possible orders. This need to represent sequential variability also comes up against a combinatorial explosion in the number of possible configurations, expressed notably by the following formula:

$${\sum }_{{p}^{′} = 1}^{{n}^{′}} \frac{{n}^{′} !}{( {n}^{′} - {p}^{′} ) !} \qquad ( 1001 )$$

in which n′ represents an integer number of tasks in a sequence and p′ an integer number varying from one to n′.

At the same time as sequential variability, other types of variability may be triggered by changes of context. For example, variabilities may be due to:
a difference in the resources which will accomplish the tasks;
a difference in the data exchanged between the tasks;
a difference in the task execution flows.

The number of possible configurations becomes too big to be modelable. The modeling of these different types of variability as a function of context with existing business process modeling languages often comes up against the complexity of the possible configurations and the complexity of the resulting business processes.

Generally, most existing studies consider the aspects relating to variability either at the architectural and application code level, or at the level of the business processes with no correlation of the two levels. Moreover, most studies at the business processes level are not concerned with dynamic variability in the context and are limited above all to the variability in the business field, also called static variability or variability of product line. The existing studies suffer from a lack of ties, or indeed of traceability between the business and technical levels relating to the aspects of dynamic variability in the context. This increases the gap between the business processes and the technical layers from the standpoint of considering this type of dynamic variability in the context. Consequently, no mechanism exists which makes it possible to automatically echo an impact of a dynamic change of context on the business processes and on the technical architecture of a complex system. The existing studies do not allow notably the management of context information and of the combinatorial explosion of configurations, at the business processes level.

An aim of the invention is notably to allow automatic management of dynamic changes of context and of their impact on the business processes as well as on the architecture and the behavior of the services offered by a complex system thus the behavior. To this end, the subject of the invention is a device for dynamically adapting a complex system to various contexts of use of the complex system. The complex system comprises a set of heterogeneous sub-systems interacting, a context being defined by a set of data characterizing a particular situation to which the complex system is subjected. The device performs an orchestration of the sub-systems by executing business processes adapted automatically by the said device to a current context. The said device takes as input a variable business process model that can vary as a function of context. A business process is a succession of tasks to be carried out by the sub-systems within the framework of a procedure specific to a technical field. The current context is a set of data characterizing the particular situation at a given instant.

The device can furthermore comprise a first component performing centralized management of the context data.

The current context may be a high-level context comprising an interpretation of a set of data of low-level contexts originating from sensors, from other types of sources, and context collectors.

The device can furthermore comprise:
a second component taking as input: the context data provided by the first component and the variable business process model, the said second component determining as a function of the current context the tasks making up the business process, generating a business process model adapted to the current context;
a third component taking as input the business process model adapted to the current context so as to generate an executable business process;
a fourth component using as input an executable business process, orchestrating the sub-systems for carrying out the executable business process.

The fourth component can replace the business process undergoing execution with a new executable business process upon a change of context.

The device can furthermore comprise:
a fifth component taking as input the variable business process model, generating an executable variable business process;
a sixth component taking as input the executable variable business process, the context data provided by the first component, generating a variable business process executable as a function of the current context, resolving the variabilities of the business processes as a function of the current context, orchestrating the sub-systems for carrying out the executable business process.

The sensors and the context sources are notably distributed in a theatre of operations.

The invention relates furthermore to a method for dynamically adapting a complex system to various contexts of use of the complex system. The said complex system comprises a set of heterogeneous sub-systems interacting. A context is defined by a set of data characterizing a particular situation to which the complex system is subjected. The said method comprises at least the following steps:
generation of a business process model adapted to the current context as a function of a variable business process model and of data of the current context;
generation of an executable business process on the basis of the business process model adapted to the context;
orchestration of the sub-systems for carrying out the executable business process.

The invention relates furthermore to a method for dynamically adapting a complex system to various contexts of use of the complex system. The complex system comprises a set of heterogeneous sub-systems interacting. A context is defined by a set of data characterizing a particular situation to which the complex system is subjected. The said method comprises at least the following steps:
generation of an executable variable business process as a function of a variable business process model;
orchestration of the sub-systems for carrying out the business process, by taking into account the executable variable business process and the data of current context.

The main advantage of the invention is notably of dynamically altering a complex system in tandem with the changes of the context. For example, the invention can allow a system for managing crises to take the proper decisions in tandem with the dynamic changes arising during the crisis situation.

Other characteristics and advantages of the invention will become apparent with the aid of the description which follows, given by way of nonlimiting illustration, and offered with regard to the appended drawings which represent:

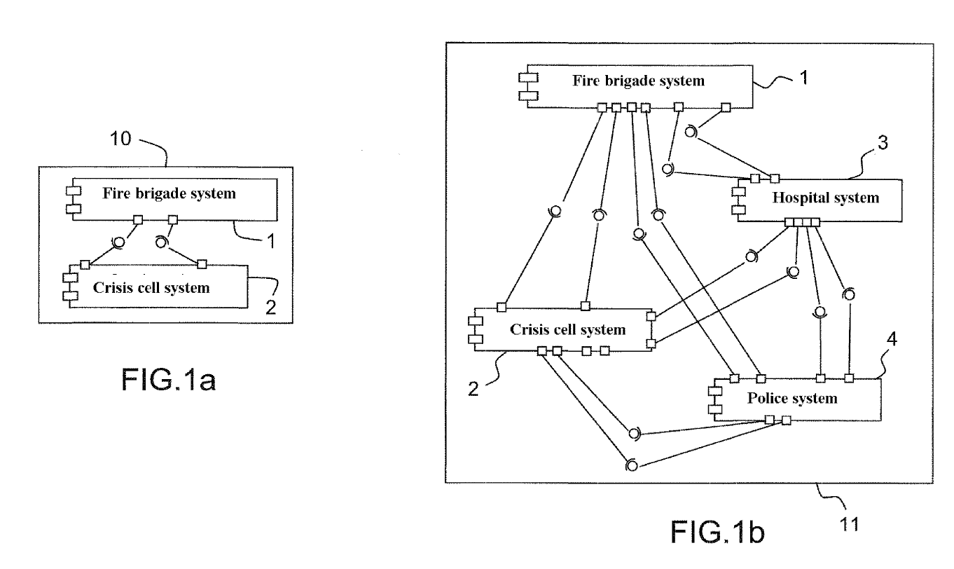

FIG. 1a: an example of a configuration of a complex system for a context of “fire with no victim” type;

FIG. 1b: an example of a configuration of a complex system for a context of “terrorist attack” type;

FIG. 1c: an example of a configuration of a complex system for a context of “aircraft accident” type;

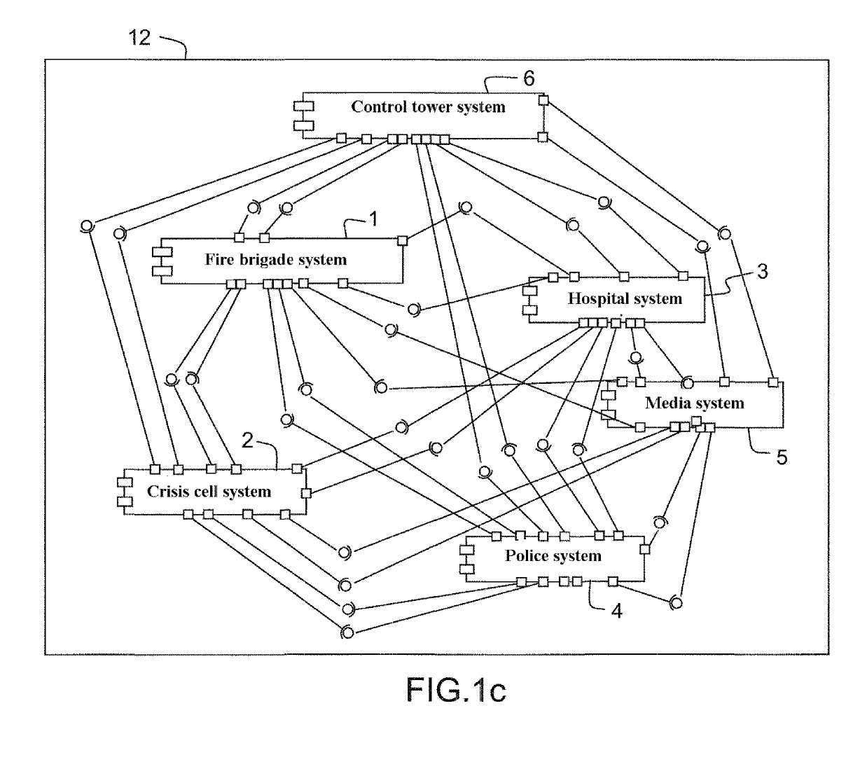

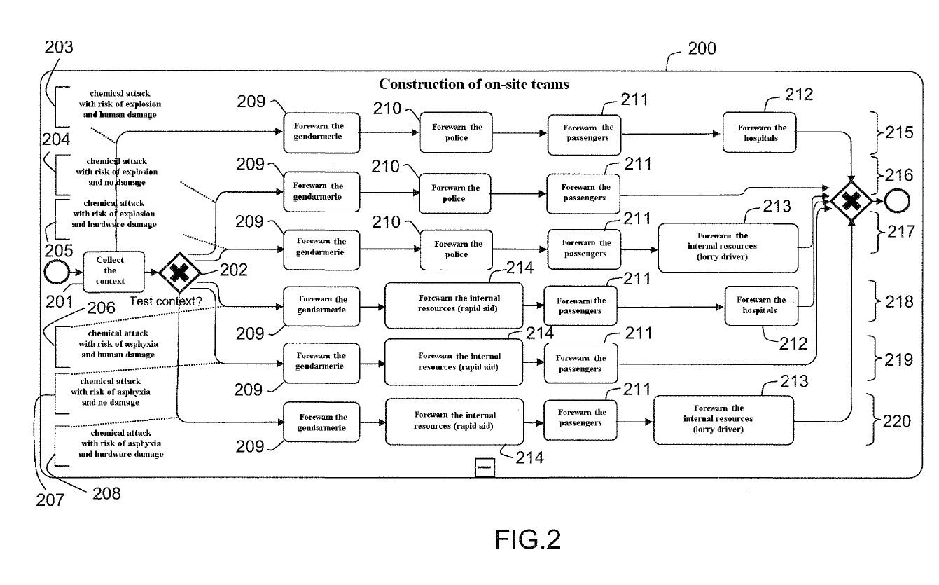

FIG. 2: an example of a business process model in the BPMN format, the acronym standing for the expression Business Process Modeling Notation, with modeling of a context in the form of business data.

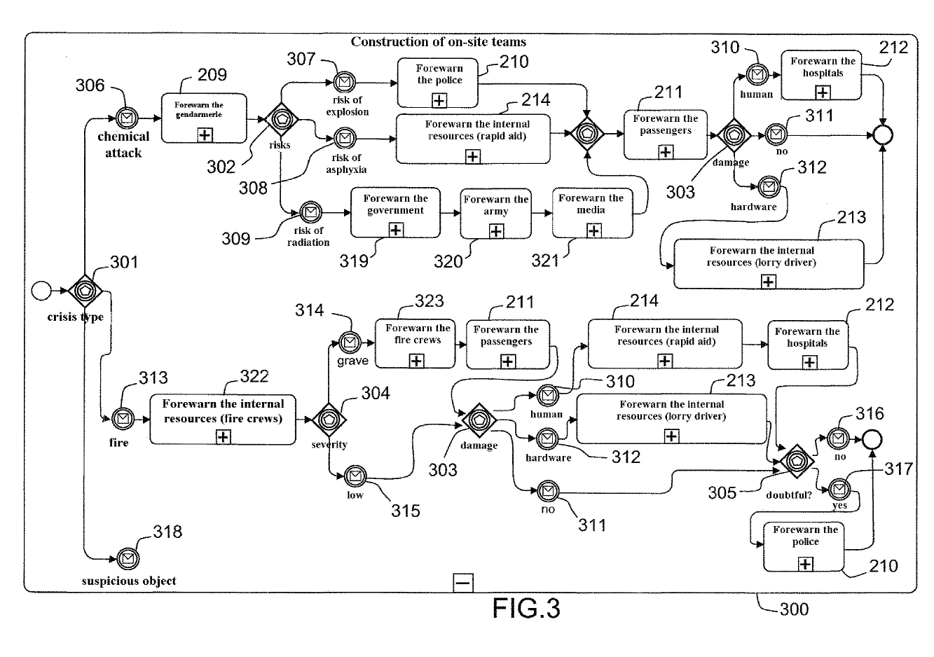

FIG. 3: an example of a business process model in the BPMN format with modeling of the context in the form of business events;

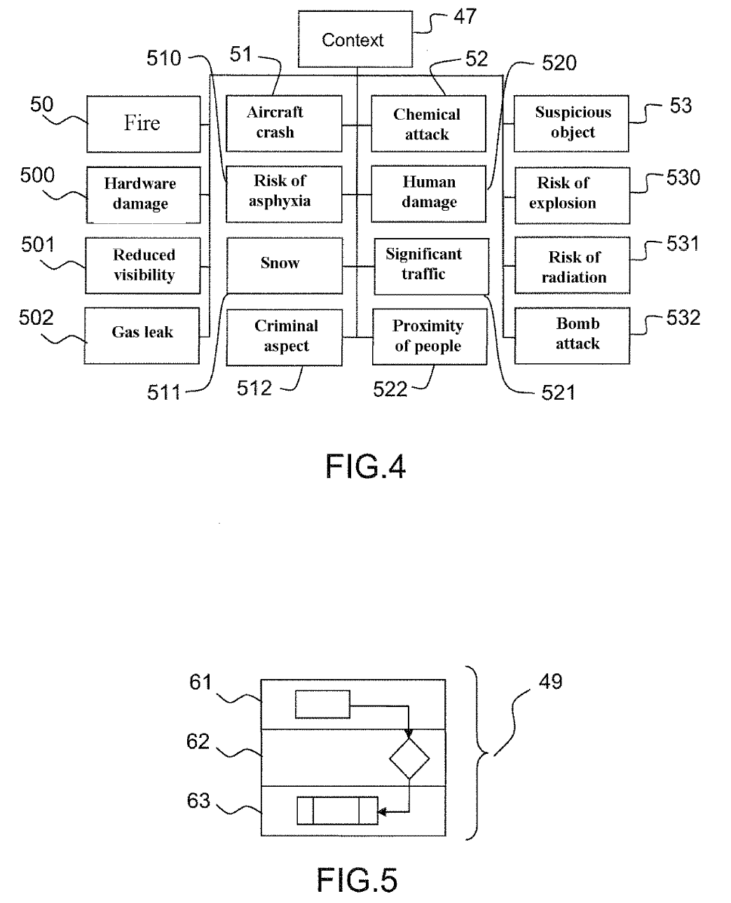

FIG. 4: an exemplary model of contextual information;

FIG. 5: an example of a part of a variable business process model;

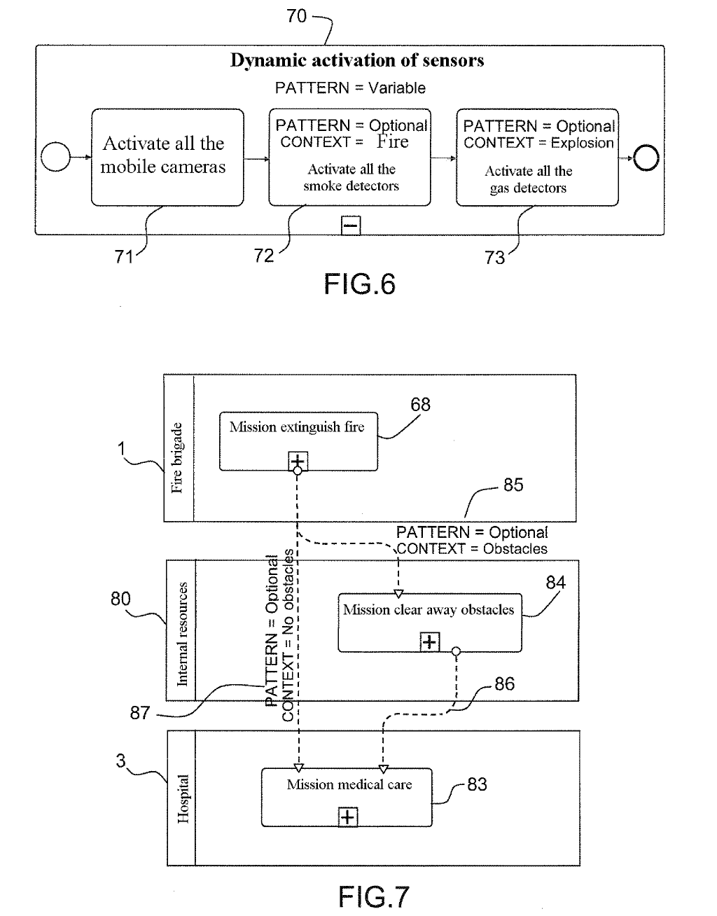

FIG. 6: a process of “variable” type with a “pattern optional”;

FIG. 7: an example of variability of message flows in a business process model;

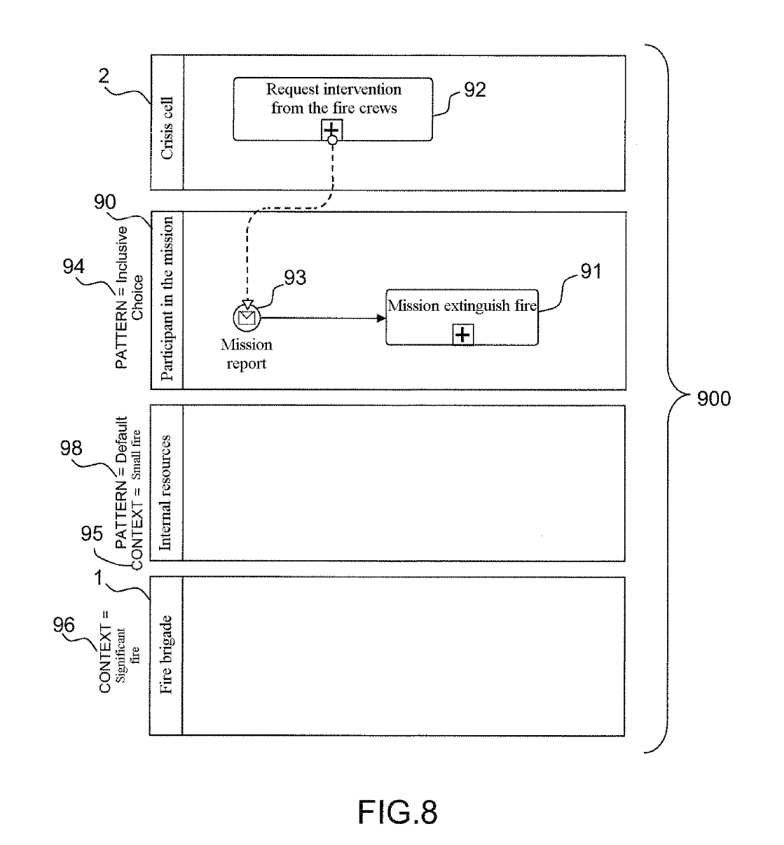

FIG. 8: an example of variability of the participants in a business process model;

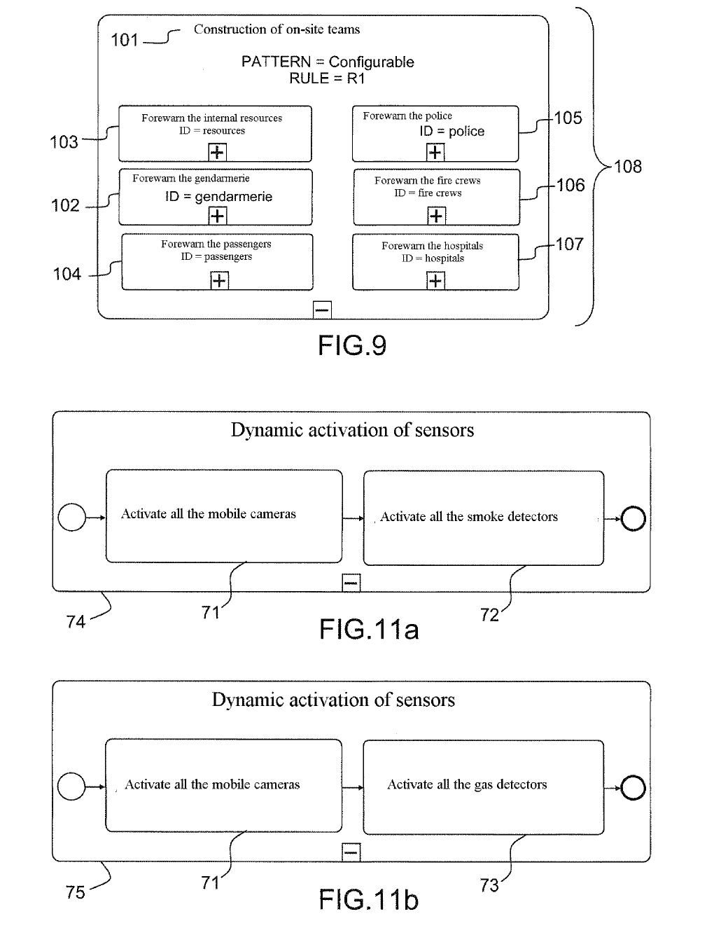

FIG. 9: an example of variability of configurable type in a business process model;

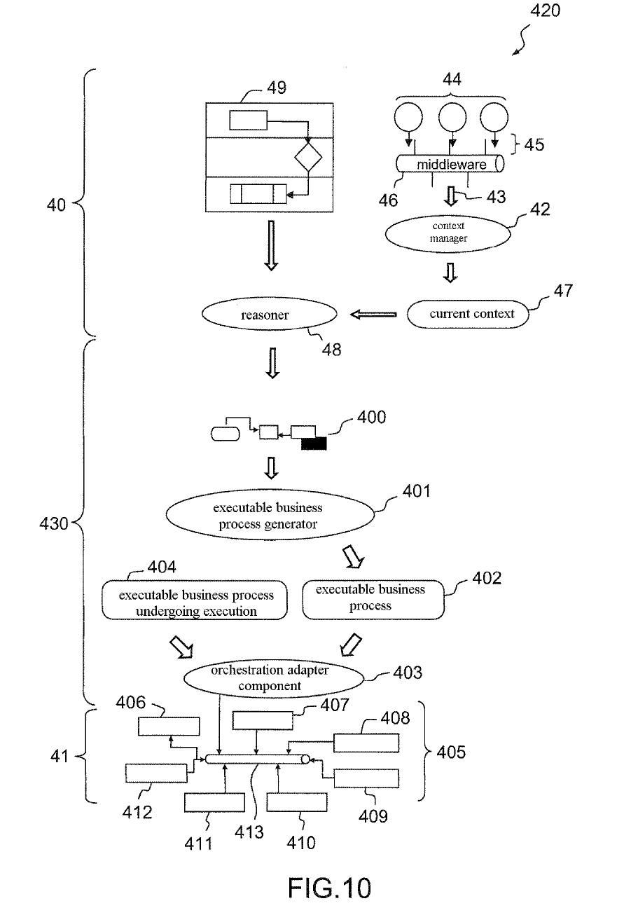

FIG. 10: a diagram of a first architecture of the device according to the invention;

FIG. 11a: a first example of a BPMN model adapted by the device according to the invention in a first given context;

FIG. 11b: a second example of a BPMN model adapted by the device according to the invention in a second context;

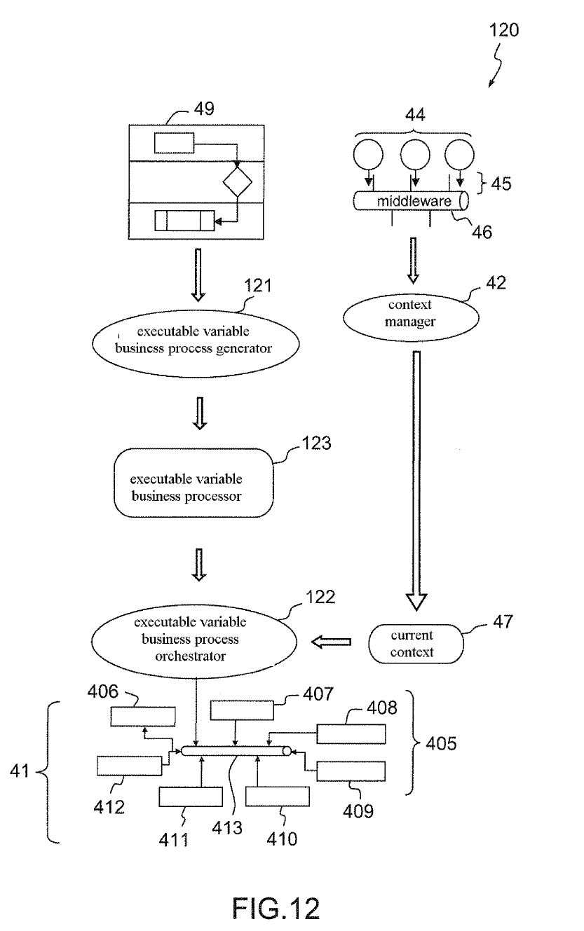

FIG. 12: a diagram of a second possible architecture of the device according to the invention.

The description of the invention is based on a system for managing crises of an airport; however, such a system is simply chosen by way of example, other systems can serve as framework for the invention.

FIGS. 1a, 1b and 1c represent examples of configurations of a complex system for various types of context. In FIGS. 1a, 1b and 1c a given configuration of a complex system corresponds to an intervention and a cooperation of one or more sub-systems with a view to resolving a crisis. In tandem with the changes in the context such as for example an evolution of the type of the crisis or climatic conditions, the complex system puts in place the most appropriate configuration best adapted to the context.

FIG. 1a presents an example of a first configuration 10 of the crisis management complex system for a context of “fire with no victim” type. In the case of a crisis corresponding to a “fire with no victim”, two systems may for example intervene to resolve the crisis: a first system 1 for managing a fire brigade, a second system 2 for managing a crisis cell in the airport. The two systems 1, 2 interact: each system can communicate information to the other system, and take into account information originating from the other system.

FIG. 1b presents an example of a second configuration 11 of the crisis management complex system for a context of “terrorist attack” type. In the case of a crisis corresponding to a “terrorist attack” four systems may for example intervene to resolve the crisis: the first system 1 for managing a fire brigade, the second system 2 for managing a crisis cell in the airport, a second system for managing a hospital 3, a third system for managing the police 4. The four systems interact and all communicate information between one another.

FIG. 1c presents an example of a third configuration 12 of a complex system for a context of “aircraft accident” type. The aircraft accident taken as example may be an explosion on a landing runway. In this kind of crisis, six systems may for example interact: the first system 1 for managing a fire brigade, the second system 2 for managing a crisis cell in the airport, the third system for managing a hospital 3, the fourth system for managing the police 4, a fifth system for managing the media systems 5, a sixth system for managing the control tower 6. The six systems 1, 2, 3, 4, 5, 6 interact and all communicate information between one another.

FIGS. 1a, 1b, and 1c show that the more sizable the impact of the crisis the more sizable the number of systems necessary for its resolution. A sizable number of systems gives rise to an escalation in the interactions between the systems and therefore to increased complexity of the crisis management system. This complexity is already formulated beforehand with the mathematical formula (1000) which calculates the impact of the changes of context on the assembly between sub-systems of a complex system.

FIGS. 1a, 1b and 1c show the impact of the changes in context on the assembly of a complex system or else the variability in the assembly of a complex system as a function of context. However, the impact of the context is not limited to the variability in the assembly of the sub-systems. Indeed, FIGS. 1a, 1b, and 1c do not give any idea of the manner in which the functionalities offered by these sub-systems are invoked nor how these sub-systems interact with one another. For example, in FIG. 1c, it is not known whether the crisis cell 2 contacts the fire crews 1 first, or whether it contacts the hospital 3 before. The configurations 10, 11, 12 represented in FIGS. 1a, 1b and 1c do not make it possible furthermore to define types of flow passing between the systems as well as their variability as a function of the evolution of a crisis.

In FIGS. 2 and 3 described hereinbelow, are represented other impacts of the changes in context on the complex system and therefore other types of variability as a function of context. FIGS. 2 and 3 illustrate notably the impact of the changes of context on the variability in a sequence flow passing between the sub-systems of a complex system.

FIG. 2 represents notably a first example of a first business process model 200. The modeling represented in FIG. 2 uses a notation according to the BPMN standard, the acronym standing for the expression Business Process Modeling Notation. A BPMN standard is notably described in the following document: “Business Process Modeling Notation (BPMN) Version 1.2, OMG Document Number: formal/2009-01-03 Standard document”.

In FIG. 2, a first sub-process “construction of on-site crisis teams” may be modeled by variations 215, 216, 217, 218, 219, 220 of a sequence of tasks. The tasks may be the following:
a first task 209: “Forewarning the gendarmerie”
a second task 210: “Forewarning the police”
a third task 211: “Forewarning the passengers”
a fourth task 212: “Forewarning the hospitals”
a fifth task 213: “Forewarning the internal resources (lorry driver)”
a sixth task 214: “Forewarning the internal resources (lorry driver)”

The tasks 209, 210, 211, 212, 213, 214, according to the business process described in FIG. 2, may be invoked in six different ways, each invocation corresponding to a given execution sequence for the tasks 209, 210, 211, 212, 213, 214 or for a subset of these tasks.

For example:
a first sequence 215 may be invoked in the following order: the first task 209, the second task 210, the third task 211, the fourth task 212;
a second sequence 216 may be invoked in the following order: the first task 209, the second task 210, the third task 211;
a third sequence 217 may be invoked in the order: the first task 209, the second task 210, the third task 211; the fifth task 213;
a fourth sequence 218 may be invoked in the following order: the first task 209, the sixth task 214, the third task 211; the fourth task 212;
a fifth sequence 219 may be invoked in the following order: the first task 209, the sixth task 214, the third task 211;
a sixth sequence 220, may be invoked in the following order: the first task 209, the sixth task 214, the third task 211, the fifth task 213.

FIG. 2 presents an example of the impact of the changes of context on the sequential order of execution of the tasks in a business process. The sequential variability in the business process is modeled in FIG. 2 by treating the context as a set of business information according to the BPMN standard. For example during the execution of the business sub-process “Construction of the on-site teams”, the context is collected once and for all by virtue of a seventh task 201 “Collect the context”. A first branching 202 “Test context” makes it possible to test the contextual data by assuming their availability at this point in time of the execution of the “Construction of the on-site teams” business process. The condition of the test is evaluated with respect to one of the six context possibilities 203, 204, 205, 206, 207, 208, represented in FIG. 2. As a function of the result of the test, a context possibility is valid and the corresponding sequence flow is executed by the complex system.

For example:
A first context possibility 203: “chemical attack with risk of explosion and human damage” causes the execution of the first sequence 215;
A second context possibility 204: “chemical attack with risk of explosion and no damage” causes the execution of the second sequence 216;
A third context possibility 205: “chemical attack with risk of explosion and hardware damage” causes the execution of the third sequence 217;
A fourth context possibility 206: “chemical attack with risk of asphyxia and human damage” causes the execution of the fourth sequence 218;
A fifth context possibility 207: “chemical attack with risk of asphyxia and no damage” which invokes the execution of the fifth sequence 219;
A sixth context possibility 208: “chemical attack with risk of asphyxia and hardware damage” which invokes the execution of the sixth sequence 220;

In FIG. 2 are represented for the example six sequence flows, or sequences, or else configurations 215, 216, 217, 218, 219, 220. But in theory, the context evolves in an exponential manner. This exponential evolution leads to a combinatorial explosion of the possible flows of sequences or configurations. This complexity is given by the mathematical formula (1001) which calculates the number of possible configurations in the case of sequential variability as a function of context.

Other types of variability can quite obviously be triggered by changes of context, for example: a variability in a flow of the data to be shifted between the tasks, in the resources executing the tasks. The number of possible configurations of the complex system therefore increases rapidly in the course of the evolution of the context of the crisis and becomes difficult to model and to manage.

FIG. 3 represents a second example 300 of modeling sequential variability as a function of context in a business process. FIG. 3 represents the same sub-process as FIG. 2: “Construction of the on-site teams”, but by modeling the context as business events according to the BPMN standard. The branchings represented in FIG. 3 are branchings on the events in contradistinction to the branching 202 represented in FIG. 2 which is a branching on the data. In FIG. 2, the context is evaluated once by virtue of the seventh task 201 “Collect the context” and a branching 202 on the data resulting from the “Test context”. Whereas in FIG. 3 the context is evaluated at each branching on the events defined in the business process. In FIG. 2, the complex system forecasts the time at which it will search for the context and it evaluates it once and for all. Within the framework of FIG. 3, the complex system does not collect the context but interprets the data arriving as and when as context events as a function of the branchings on the events forecast during the execution of the business process.

FIG. 3 represents a way of taking the context information into account in the description of the various possible sequences of execution of the tasks 209, 210, 211, 212, 213, 214 represented in FIG. 2. For example, FIG. 3 represents the business process by taking into account a type of crisis 301 which may be:
a chemical attack 306;
a fire 313;
a suspicious object 318.

Depending on the type of crisis 301, the task sequence engaged may therefore be different. For example, for a chemical attack 306, the first task to be accomplished may be the first task 209 “forewarn the gendarmerie”; for a fire 313, the first task to be accomplished may be an eighth task 322 “forewarn the internal resources (fire crews)”.

Thereafter, depending on a type of risk 302, the task following the first task 209 may be:
the second task 210 “forewarn the police” if the type of risk 302 is “risk of explosion 307”;
a sixth task 214 “forewarn the internal resources (rapid aid)”, if the type of risk 302 is “risk of asphyxia” 308;
an eighth task 319 “forewarn the government”, if the type of risk 302 is “risk of radiation” 309.

Thereafter, a task following the eighth task 319 “forewarn the government” may be a ninth task 320 “forewarn the army”, and then a tenth task 321 “forewarn the media”.

Whatever the type of risk 302, the following task is a third task 211 “forewarn the passengers”. Next, depending on a type of damage 303, i.e.:
the fourth task 212 “forewarn the hospitals” is carried out when the type of damage 303 is “human” 310;
the fifth task 213 “forewarn the internal resources (lorry driver)” is performed if the type of damage is hardware 312;
no other task is accomplished if the type of damage 303 is “no” 311, that is to say there is no damage.

In the business process represented in FIG. 3, when the eighth task 322 has been accomplished, when a type of severity 304 is “severe” 314, the following tasks are performed: an eleventh task “forewarn the fire crews” 323 and then the third task 211 “forewarn the passengers”. Thereafter, and also when the type of severity 304 is “low” 315, the type of damage 303 is evaluated. Depending on the type of damage 303 the following tasks may be performed:
for a type of damage 303 “human” 310: “forewarn the internal resources (rapid aid)” 214, and then “forewarn the hospitals” 212;
for a type of damage 303 “hardware” 312: “forewarn the internal resources (lorry drivers)” 213;
for a type of damage 303 “no” 311, no particular task.

Thereafter, depending on a type of doubt “doubtful?” 305 either the response is “yes” 317 and the first task 210 “forewarn the police” is accomplished, or the response is “no” 316 and no particular task is carried out.

In FIG. 3, a complexity of description of the process is also noted, made worse with respect to FIG. 2 by the fact that the order of arrival of the context information may be permuted into any a priori order. For example the criminal, or “doubtful” 305, aspect of the crisis may be detected before ascertaining the type of severity 304. The type of damage 303 caused by the crisis may be detected before ascertaining the type of severity 304 of the crisis. Management of the context is made more complex because of the dynamic aspect of the context information. Fixing an order of receipt of the context information, such as is represented in FIG. 3, for example of the type of crisis 301 and then of the type of damage 303 can disable the process in the case where the type of damage 303 contextual information is received before the type of crisis 301 contextual information. Specifying all the possible orders of receipt of contextual information can lead to a model of such complexity that it is undefinable.

FIGS. 2 and 3 show that the description of the context and of its impact with the contemporary semantics of business processes leads to enormous complexity. Representing the variability with existing languages for modeling and executing business processes leads to exponential complexity in the possible configurations to be modeled and developed. With the aid of the contemporary semantics of BPMN, it is possible to avoid specifying all these possible configurations and to model the variable parts in business processes as an abstract black box with no details. The automation and the generation of code on the basis of the variable parts is therefore not possible since these parts are not specified in detail during the modeling. This results in partially automatable and executable business processes since only the invariable parts in the business processes can be automated. Business process models are merely a high-level image of an application architecture of the system that can have no link with a design of the system itself.

FIGS. 4 and 5 described hereinbelow represent two steps in the methodology advocated according to the invention for resolving the complexity engendered by the management of the context and of its impact, and explained previously in the description of FIGS. 1, 2 and 3. FIGS. 4 and 5 represent respectively an exemplary context model and mechanisms facilitating a description of variability by using the contemporary semantics of business processes.

FIG. 4 represents an example of a context model grouping together the contextual information that may impact the complex system. A current context 47 represented in FIG. 4 is a given state or a given instance of the context model. The current context 47 therefore comprises information relating to a context of crisis at a given instant of the execution of the complex system such as: a fire 50, an aircraft crash 51, a chemical attack 52, a discovery of a suspicious object 53. Thereafter for each type of crisis context, it is possible to retrieve the following information:
for a fire 50: presence of hardware damage 500, of reduced visibility 501, of a gas leak 502;
for an aircraft crash 51 and a chemical attack 52: presence of a risk of asphyxia 510, of snow 511, of a criminal aspect 512, of human damage 520, of significant traffic 521, of proximity of persons 522;
for a suspicious object 53: presence of a risk of explosion 530, of a risk of radiation 531, of a bomb attack 532.

A model of contextual data such as is represented for example in FIG. 4 may be produced by an analyst specializing in a particular field such as crisis management. The analyst can for example identify and specify a set of context data liable to have an impact on the complex system in general and on these business processes in particular.

The business analyst passes to the modeling of the complex system by business processes and he models the variability as a function of the context applied to the business process. Such business processes are variable as a function of context.

FIG. 5 represents a non-detailed example of a context-dependent variable business process model 49. Examples of variable business process models 49 such as these are detailed in FIGS. 6, 7, 8 and 9 described hereinbelow.

For example a system for managing first aiders 61 who are present in an airport can communicate to a system for managing the fire crews 63, an electronic report 62 on the situation of the crisis, consultable from mobile terminals of the fire crews. According to the context of intervention of the fire crews namely “proceeding towards the airport” or “at the location of the crisis”, the report dispatched may be in a voice or text form. In this process, the changes of context impact the flow of data exchanged. The variable business process model 49 can in this case provide for two variants of data flow, one for the voice report and one for the text report. The variability here is in the data flow namely the report dispatched 62.

Thus for each business process, a business analyst can define a first variable business process model 49. The first variable business process model 49 may be defined on the basis of a business process model enriched by elements taking into account a variability as a function of a context. Such a first variable business process model 49 may be produced by investigating types of variability that may result from changes of context. The business process models can therefore be supplemented with “patterns” of variability and contextual information. In the field of system design, a “pattern” is by definition a pattern that may be repeated in an object model for example. A pattern represents a phenomenon that can be observed repeatedly when investigating certain subjects on which it may confer characteristic properties. Examples of patterns are represented in FIGS. 6, 7, 8, 9, 10, 11, 12. A set of patterns can, for example, be defined so as to indicate in a business process model the impact of a context on elements of the business process, that is to say artifacts produced by a change of context on the elements of the business process.

The following patterns can for example be used:
A first “pattern optional” can indicate that an element of a business process is taken into account only when the current context fulfills indicated conditions. The “pattern optional” may be applied to tasks, sub-processes, activity flows, message flows, events or data.
A second “pattern default” may be applied when an element of a business process can be constructed in several ways as a function of the context. A default construction may be indicated if all the specified contexts are not satisfied at the time of execution of the process. The “pattern default” makes it possible to avoid cases unresolved by the reasoner 48 represented in FIG. 10. The “pattern default” may be for example applied to a task, a sub-process or a participant.
A third “pattern parallel” may be used to indicate that according to a given context several elements of a business process may be executed in parallel. The “pattern parallel” may be applied to a task or a sub-process.
A fourth “pattern sequence” may indicate that according to a given context, several elements of a business process may be executed sequentially. The “pattern sequence” may be applied to a task or a sub-process.
A fifth “pattern exclusive choice” may indicate that there exist several possibilities of execution of one or more of a business process according to the context. The possibilities of execution are mutually exclusive. In a determined context, one and only one possibility or variant is chosen in order to carry out the business process. The “pattern exclusive choice” may be applied to a sub-process, an event, an item of data or a participant.
A sixth “pattern inclusive choice” may indicate that several possibilities of execution of a business procedure may be applied. A coexistence of the possibilities of execution if at the time of execution several context states validate at the same time specified execution conditions for these variants. The “pattern inclusive choice” may be applied to sub-processes, events, data or participants.
A seventh “pattern variable” indicates that an element of a business process can have several possibilities of execution according to the context, the various possibilities not being exclusive or inclusive with respect to one another. The seventh “pattern variable” may be applied to a sub-process.
An eighth “pattern configurable” indicates that an element of a business process can have several possibilities of execution according to the context and that these possibilities are described in a declarative manner with the aid of contextual configuration rules. The eighth “pattern configurable” may be applied to a sub-process, an item of data, an event or a participant.
A ninth “pattern skipped” may indicate that an element of a business process is neglected in the case of a given context. A “pattern skipped” may be applied to a task or a sub-process.
A tenth “pattern before” indicates that an element of a business process is taken into account before another element in the case of a particular context. A “pattern before” may be applied to a task or a sub-process.
An eleventh “pattern after” indicates that an element of a business process is taken into account after another element in the case of a particular context. A “pattern after” may be applied to a task or a sub-process.
A twelfth “pattern inclusion”, indicates that a given element includes another element in a given context. A “pattern inclusion” may be applied to a task or a sub-process.
A thirteenth “pattern exclusion”, indicates that a given element excludes another element in a given context. A “pattern exclusion” may be applied to a task or a sub-process.

FIGS. 6, 7, 8 and 9 represent examples of context-dependent variable business processes using the variability patterns proposed and advocated by the methodology according to the invention for resolving the complexity explained by the description of FIGS. 1, 2 and 3.

FIG. 6 represents a first example of variable business sub-process 70 according to a “pattern optional”. The “Dynamic activation of the sensors” business sub-process 70 is described according to the BPMN standard. The “Dynamic activation of the sensors” business sub-process 70 describes tasks to be carried out so as to dynamically activate sensors in an airport. Indeed, in an airport the sensors are not all initially activated for energy economy reasons for example. The “Dynamic activation of the sensors” business sub-process 70 may be impacted by contextual information of “fire” and “explosion” type. Indeed, in case of fire, the airport's management system activates the smoke detectors in the zone of the fire so as to ascertain the evolution of the fire and its perimeter. In the case of explosion, the airport's management system activates gas detectors so as to verify any gas leak that may be due to an explosion and to ascertain the perimeter of a gas leak. The “variable” variability pattern indicates that the “Dynamic activation of the sensors” business sub-process 70 is variable, that is to say the context can modify the tasks to be accomplished within the framework of the “Dynamic activation of the sensors” business sub-process 70.

The “Dynamic activation of the sensors” business sub-process 70 comprises the following tasks performed in the order cited:
a first task 71 may be: “Activate the mobile cameras”;
a second task 72 may be “Activate all the smoke detectors”. The second task 72 can incorporate a variability pattern of “Optional” type for a “fire” context. The second task is therefore carried out solely in the presence of a fire;
a third task 73 may be “Activate all the gas detectors”. The third task 73 can incorporate a variability pattern of “optional” type for an “explosion” context. The third task 73 is therefore carried out solely in a context of explosion.

The annotation “CONTEXT=Fire” mentions the context impacting the second task “Activate all the smoke detectors” 72. The annotation “CONTEXT=explosion” mentions the context impacting the third task “Activate all the gas detectors” 73.

FIG. 7 presents an example of variability in a flow of messages between various participants 1, 3, 80 to a business-process. For example, the system, or the participant, of the fire brigade 1 can perform notably a task or a sub-process “mission extinguish the fire” 68. A system for managing internal resources 80, for example of an airport, can perform notably a task or a sub-process “mission clear away obstacles” 84. The hospital management system 3 can perform a “medical care mission” 83. The task “extinguish the fire” 68 may be executed first. Thereafter the task to be executed may be: either the “clear away obstacles” task 84 in the case where victims are disabled in the craft corresponding to the “Obstacles” context, or the “medical care” task 83 in the converse case corresponding to the “No obstacles” context. The two flows 85, 87 heading from the task “extinguish the fire” 68 respectively towards the two tasks “clear away obstacles” 84 and “medical care” 83 may be annotated with the “optional” variability pattern. The variability pattern can be split up according to the context into “Obstacles” for the first flow 85 and into “No obstacles” for the second flow 87. The content of these two flows varies as a function of the context. In the case of the “obstacles” context it contains the location of the obstacles and in the case of the “no obstacle” context it contains the description of the state of the victims. After the “clear away obstacles” task 84, the “medical care” task 83 is accomplished whatever the context.

The variability of a flow of messages can also result in variability of the content of the message dispatched.

FIG. 8 represents an example of variability in the participants in the management of the resolution of the crisis. FIG. 8 shows notably the impact of a context on the variability of the participants. The participants may be systems taking part in the resolution of the crisis. Depending on the context and its evolution one and the same task may require the intervention of several participants.

FIG. 8 represents for the example a fourth model 900 comprising three concrete participants 1, 2, 80: a fire brigade 1, a crisis cell 2, internal resources 80.

When the crisis cell 2 performs a task of requesting intervention from the fire crews 92, for example in the case of a fire, then it transmits a mission report 93. For example, the “Mission extinguish fire” task 91 requires at the start of the fire, that is to say in a context of “Small Fire” 95, an intervention by the internal resources of the airport 80. In case the fire should worsen, the context becomes “Significant Fire” 96. The same “Mission extinguish fire” task 91 then also requires an intervention by the fire brigade 1. The fourth model 900 can comprise an abstract participant “Participant to the mission” 90. The abstract participant can in principle be substituted either for the internal resources 80 or for the fire brigade 1, or both for the internal resources 80 and for the fire brigade 1. For this purpose, the abstract participant 90 is annotated with a variability pattern of “Inclusive Choice” 94 type and the concrete participants are then determined according to the context: the participant “Resources internal” 80 in the “Small Fire” context 95 and the participant “Fire brigade” 1 in the “Significant Fire” context 96. A pattern of “default” type 98 can also annotate one of the concrete participants, so as to choose the default participant in a case where the context is not known.

FIG. 9 represents an example of variability of configurable type.

FIG. 9 gives an exemplary use of the “Configurable” variability pattern 100. The “Configurable” pattern 100 makes it possible to specify for example a sub-process “Construction of the on-site teams” 101 used for the construction of a team so as to cope with a given crisis situation. The “Configurable” variability pattern 100 makes it possible to avoid a complexity of a fifth model 108 for the sub-process “Construction of the on-site teams” 101 such as the complexity of the models represented in FIGS. 2 and 3. The “Configurable” variability pattern 100 makes it possible to specify tasks without specifying any relationship between them nor any particular order of execution. The interactions between the tasks as well as their order of execution may be specified by contextual rules. The contextual rules may be introduced into a model via annotations of “Configurable” type 100 attached to the sub-processes of the model. FIG. 9 illustrates an annotation by the “Configurable” pattern 100, using for example a contextual rule “RULE” denoted for example R1. In order to be able to reference the variable tasks of the sub-process “Construction of the on-site teams” 101 in rules, their own inherent identifier is ascribed to them. For example, a task “forewarn the gendarmerie” 102 can have an identifier “ID” equal to “gendarmerie”. In the same manner and for example:
a task “forewarn the internal resources” 103 has “resources” as identifier;
a task “forewarn the passengers” 104 has “passengers” as identifier;
a task “forewarn the police” 105 has “police” as identifier;
a task “forewarn the fire crews” 106 has “fire crews” as identifier;
a task “forewarn the hospitals” 107 has “hospitals” as identifier.

The rule R1 itself may be specified in a declarative manner by the following lines:
‘Line 1—“Chemical attack”: “gendarmerie”
Line 2—“Explosion”: Parallel(“passengers “,” police”)
Line 3—“Human damage”: Sequence(“resources”,“hospitals”)
Line 4—“End of the crisis”: Exit’

The format of the context rules may be an n-tuple described for example according to the following Backus-Naur form: <context> “:” <element>|<pattern> “(“<element+>”)” {“,”<pattern> “(” <element+>)”}*. The Backus-Naur form is a notation making it possible to describe syntactic rules of programming languages, it is a metalanguage.

“Line 1” is a (context, task(id)) pair indicating that: if the “Chemical attack” context is satisfied then the task whose identifier is “gendarmerie” is executed. In the example of line 1 hereinabove, this is the task “forewarn the gendarmerie”. “Line 2” is a pair of (context, pattern(tasks)). The pattern used in “Line 2” is the “Parallel” pattern which triggers the execution of two tasks in parallel: “forewarn the passengers” and “forewarn the police” in the case of the “Explosion” context. “Line 3” complies with the same drafting principle as “Line 2”. The “Sequence” pattern executes two tasks sequentially in the order mentioned: firstly it executes the task “forewarn the resources” and then the task “forewarn the hospitals”. “Line 4” specifies a dependency with a lifetime of the sub-process “Construction of the on-site teams” 101 as a function of context: Construction of the on-site teams is a continuous process which executes until the end of the crisis. The end of the crisis gives rise to an exit from the process, denoted by “Exit”.

The annotations related to the above-described patterns may be implemented with the aid of most existing business process modeling environments.

FIGS. 10, 11a, 11b and 12 represent the invention proper. Whereas FIGS. 5, 6, 7, 8, 9 represent the methodological part, or the method, proposed by the invention, FIGS. 10, 11a, 11b and 12 represent the device part of the invention.

FIG. 10 represents a diagram of a first architecture 420 of the device according to the invention. This architecture makes it possible to capture the dynamic changes in context, to configure the business processes in real time according to the current context 47, to generate the adaptations to be made to the technical architecture of the complex system and to migrate it to its new technical architecture. FIG. 10 represents notably architectural portions 40 of a management of variability of business processes as a function of a context and architectural portions 49 of a management of the impact of this variability on the architecture of the services according to the invention. FIG. 10 also represents an architecture of services 41 offered by component systems of a complex system 405 as well as the interactions between the various systems. For the example, the complex system 405 comprises following systems:
a first system 406 for detecting alerts;
a second system 407 for managing alerts;
a third system 408 for aiding decision;
a fourth system for crisis management 409;
a fifth dashboard system 410;
a sixth system 411 for managing hospitals;
a seventh system 412 for managing fire crews;

The whole set of systems 406, 407, 408, 409, 410, 411, 412 of the complex system 405 is linked to one and the same network 413. The various systems can for example be linked to one and the same bus for example a bus using an ESB technology. ESB is an acronym standing for the expression Enterprise Service Bus. ESB technology makes it possible to establish a communication between applications of heterogeneous systems which are not being carried out to communicate with one another.

The architecture 40 for managing business process variability as a function of context comprises a context manager 42. The context manager is a computerized application able to be implemented by a computer. The context manager 42 collects context information 43 originating from various context sensors 44. Context sensors may be for example: heat sensors, mobile or fixed video cameras, location detectors. The various sensors 44 are distributed over a network and publish the context information 45 that they generate on a message-oriented “middleware” 46, middleware being an expression denoting mediator or interface software. The context manager 42 makes it possible to aggregate and to interpret context information so as to deduce therefrom a definition of a current context 47. A context interpretation makes it possible to define a more meaningful context on the basis of the raw information dispatched by the sensors. By way of example, the GPS coordinates on the position of a security agent in the airport form its raw context dispatched by the GPS sensor of his portable telephone. A context manager can interpret these GPS coordinates so as to provide a more meaningful context such as for example the position of the agent on a real or synthetic map of the airport. The context manager 42 can implement context collection, aggregation and interpretation mechanisms such as described by A. K. Dey, G. D. Abowd, and D. Salber in “A conceptual framework and toolkit for supporting the rapid prototyping of context-aware applications” from “Human-computer Interaction, 16(2-4 (special issue on context-aware computing)): 97-166, December 2001”, and by Davy Preuveneers, Yolande Berbers in “Adaptive context management using a component-based approach” from “Proceedings of the 5th Ifip International Conference on Distributed Applications and Interoperable Systems, DAIS 2005, pages 14-26, vol 3543, June 2005, Athens, Greece”. For example, the context manager 42 can aggregate context information collected by a set of fire detectors. The context manager 42 can deduce from the aggregated context information that an explosion has occurred in a well-determined zone of an airport, for example.

The context 47 provided by the context manager 42 may be placed at the disposal of a reasoner 48. The reasoner 48 is a computerized application able to be implemented by a computer. The reasoner 48 takes as input a process business model 49 enriched with elements making it possible to express the variability of the complex system as a function of context. The reasoner 48 determines, on the basis of the context 47 and of the process business model 49, the process best adapted to the current context 47. The reasoner 48 produces a third process model 400 adapted to the current context 47.

The third process model 400 is thereafter used as input data to an executable business process generator 401. The executable business process generator 401, generates an executable code which implements the process which orchestrates the services offered by a complex system which is an executable business process 402. The executable business process contains the description of the technical architecture of the complex system i.e. the description of the services provided by the sub-systems, the data exchanged and the various processing to be done. The executable business process may be implemented by software called an orchestrator or orchestration engine. The business process generator 401 can for example carry out a transformation of a model described according to the BPMN standard into an executable generated according to a BPEL standard format. BPEL is an acronym standing for the expression Business Process Execution Language. A scheme for transforming a BPMN model into a BPEL executable is notably described in the document “Business Process Modeling Notation (BPMN) Version 1.2, OMG Document Number: formal/2009-01-03 Standard document” p. 143.

The executable business process 402 corresponding to the current context 47 is thereafter provided to an orchestration adapter 403. The role of the orchestration adapter 403 is to put in place the executable business process 402. This putting in place is done by migrating the executable business process undergoing execution 404 to the appropriate executable business process 402 with the current context 47. Therefore, in addition to usual functionalities of orchestration between various systems or sub-systems, the orchestration adapter component 403 comprises functionalities allowing it to replace a process undergoing execution by another, while taking into account a state of a previous executable process 404, the said previous executable process 404 currently undergoing execution. The role of the orchestration adapter 403 is therefore to orchestrate the various component systems 406, 407, 408, 409, 410, 411, 412 making up the complex system 405. The complex system 405 having an architecture based on its composition with the independent systems 406, 407, 408, 409, 410, 411, 412.

FIGS. 11a and 11b represent examples of models of sub-processes presented according to the BPMN standard. FIGS. 11a and 11b represent respectively the result of the adaptation by the reasoner 48 of the variable process model represented in FIG. 6 in the two respective contexts “Fire” and “Explosion”.

The modeling environment used by the method according to the invention can make it possible to store business process specifications with their annotations. One of the examples of database storage format is the XML format, XML being an acronym standing for eXtensible Markup Language. An annexe 1 gives an example of a first XML code file generated to describe the variability of the “Dynamic activation of the sensors” business sub-process 70.

At the time of execution, the reasoner 48 represented in FIG. 10, can use as input:
collected and aggregated context information, transmitted by the context manager 42, in the form of an instance of the context model represented in FIG. 4 for example.
the business process model 49, annotated with the different patterns of variability as a function of context such as they have been illustrated in FIGS. 6, 7, 8 and 9, in the form of the first XML code file of annexe 1 for example.

The reasoner 48 performs a syntactic analysis of the first XML code file. For each annotation found, the reasoner 48 verifies that the context information item mentioned in the first XML code file is valid based on the context provided by the context manager 42. When this is the case, the reasoner 48 interprets the pattern used in the annotation and generates in tandem with this reading a second code file containing the business process adapted to the current context in the XML format for example. Annexe 2 presents, by way of example, the second XML code file representing the business process adapted to the context, generated by the reasoner 48, on the basis of the variable business process represented in FIG. 6 in the case of a “Fire” context.

FIG. 11a represents a seventh model 74 of the “Dynamic activation of the sensors” business sub-process 70 without variability associated with the second XML file, generated by the reasoner 48 in the case of a “Fire” context.

Annexe 3 presents an example of a third XML code file of the business process adapted to the context, generated by the reasoner 48 on the basis of the “Dynamic activation of the sensors” business sub-process 70 in the case of an “Explosion” context.

FIG. 11b represents the model of the “Dynamic activation of the sensors” business sub-process 70 without variability associated with the third XML code file exhibited in annexe 3.

The reasoner 48 can therefore take as input the first XML code file of annexe 1 and the collected context information. The following describes in a concrete example, a possible manner of operation of the reasoner 48. The reasoner 48 firstly interprets a first subsequent line: @PATTERN=“Variable”. The first line indicates that the sub-process is variable. Thereafter, the reasoner 48 interprets the first XML code file line by line until it reaches a second line @PATTERN=“Optional”, CONTEXT=“Fire”. The reasoner 48 interprets the second line as a variability of “Optional” type and it verifies that the context information item is “Fire”. The reasoner 48 then takes into account the subsequent states in the second XML code file that it generates. The reasoner 48 continues to interpret and copy over the lines of the first XML code file until it finds a third subsequent annotation line comprising the annotation PATTERN=“Optional”, CONTEXT=“Explosion”. The “Explosion” context information item not being satisfied, the lines subsequent to the third annotation line PATTERN=“Optional”, CONTEXT=“Explosion” are not copied over into the second XML code file generated by the reasoner 48. This amounts to replacing in the second XML code file generated the transition <transition to =“Activate all the gas detectors” g=“30,18”/> with the transition <transition to =“end” g=“30,18”/>. Since the state <state name=“Activate all the gas detectors” g=″143,147,92,52″> corresponding to the first transition is optional, the reasoner 48 deduces that this transition to this state is likewise optional, the letter g indicating the graphical positioning of the element.

A processing according to the same principle is carried out by the reasoner 48 for each of the variability patterns, with the exception of the “Configurable” pattern. For the “Configurable” pattern, management of variability as a function of context is managed by contextual rules. In this case, the reasoner interprets the contextual rules as and when, at each update of the context and generates the XML code describing the business process as a function of the variability patterns used in each business rule. The reasoner can use several types of algorithms to resolve the systems of rules such as the algorithm of RETE type such as described by Forgy, Ch.: “Rete: A Fast Algorithm for the Many Patterns/Many Objects Match Problem”. Artif. Intell. 19(1): 17-37 (1982). By taking for example FIG. 9 which represents the configurable process “Construction of the on-site teams” 101 with a single contextual configuration rule R1. Let us assume that only the contextual information item “Human damage” is available on execution of the complex system, the reasoner 48 then interprets the rule which depends on this contextual information item namely R1 and generates the XML code corresponding to the variability pattern associated with this context namely Sequence(“resources”,“hospitals”).

The business process adapted to the context, generated by the reasoner in the form of the second XML code file or of the third XML code file, is used as input to the executable business process generator component 401 represented in FIG. 10. The executable business process generator 401 transforms the XML code file adapted to the context into an executable business process 402 such as represented in FIG. 10. Annexe 4 describes an example of a first executable business process code file in the BPEL standard format. The first executable business process code file corresponds to the file generated on the basis of the second XML code file of the business process adapted to the “Fire” context. Annexe 5 describes an example of a second executable code file in the BPEL standard format. The second executable code file corresponds to the file generated on the basis of the third XML code file of the business process adapted to the “Explosion” context.

The orchestration adapter component 403 represented in FIG. 4 uses as input an executable code file in the BPEL format such as the first BPEL file described in annexe 4 or the second BPEL file described in annexe 5. The orchestration adapter component 403 performs the following processing operations in order:
recovery of the execution state of the executable process 404 undergoing execution, the execution state of the process comprising the state of the tasks undergoing execution, the data transferred between the tasks or the branchings which are undergoing evaluation;
standby awaiting a stable execution state of the executable process 404, that is to say the end of the tasks undergoing execution, the end of the transfer of the data in progress or the end of the evaluation of the branchings in progress;
halt the process 404 undergoing execution once it reaches a stable state;
instantiation of the new executable process 402 adapted to the current context and generated by the executable business process generator 401;
start of the execution of the new executable process 402 with consideration of the execution state of the previous executable process 404, that is to say the task on the basis of which the new process 402 will commence, the content of the data which will be at its disposal when it starts.

The orchestration adapter 403 orchestration functionalities allowing it to start the execution of an executable process may be for example carried out in accordance with the specification (Web Services Business Process Execution Language Version 2.0, OASIS Standard, 11 Apr. 2007).

FIG. 12 represents a diagram of a second possible architecture 120 of the device according to the invention. The second architecture 120 employs the components of the first architecture 420, represented in FIG. 10 with the exception of the following components:
the reasoner 48;
the executable business process generator 401;
the orchestration adapter 403.

The reasoner 48 is replaced in the second architecture 120 by an executable variable business process generator 121.

The executable business process generator 401 and the orchestration adapter 403 are replaced in the second architecture 120 by an executable variable business process orchestrator 122. The executable variable business process generator 121 uses as input the variable process model 49. The model 49 can for example take the form of a model according to the BPMN standard annotated as a function of context with variability patterns. The executable variable business process generator 122 transforms the variable process model 49 into an executable variable business process 123. The executable variable business process 123 may be written according to the BPEL standard for example and annotated as a function of context with variability patterns. The executable variable business process 123 is thereafter taken as input for the executable variable business process orchestrator 122. The executable variable business process orchestrator 122 fulfills at one and the same time the functions of reasoning on the current context, and the deployment of the executable processes. Indeed, the executable variable business process orchestrator 122 takes into account the current context 47 so as to specify and to generate an executable variable business process as a function of the current context 47. The deployment of the executable processes is carried out in parallel with a resolution of the variability of the variable executable business processes 122 as a function of the available context 47. In the case of the use of the BPMN and BPEL standards, the executable variable business process orchestrator 122 may be an intelligent “BPEL annotated with a context-dependent variability” engine, which therefore deploys, as a function of the current context 47, determinable parts in the BPEL file and ignores other parts, doing so as a function of the variability patterns annotating these parts. The mechanism that it uses to determine the relevant parts of the BPEL file as a function of the current context is the same as the mechanism used by the reasoner to construct the third business process model 400 represented in FIG. 10.

The advantage of the second architecture 120 is that it makes it possible for the context to be taken into account as late as possible in the generation of the executable process, thereby making it possible to have an impact which is both fast and dependent on the most recent context, on the technical architecture 405 represented in FIG. 10.

The device according to the invention may be used to adapt various types of complex architectures, for example:
for ubiquitous, mobile, ambient or pervasive systems, that is to say scattered through all the parts of the information system: these systems are based on networked processing devices, integrated and distributed throughout the extent of daily life, and oriented towards commonplace applications. These systems afford the user the capacity “to interact (actively or passively), anywhere, with a multitude of interconnected apparatuses, of sensors, of activators, and more globally with the electronic systems “embedded” around him”. For example, a surveillance system for monitoring the elderly at home which uses RFIDs (Radio Frequency Identification) and which automatically makes calls to services such as emergency services as a function of their states and situations. Another example, “a domestic ubiquitous system which can link all the lighting and environment controls with individual biometric sensors so as to modulate the lighting and heating in a room accordingly”;
within the framework of “smart cities”, “cyber cities” or intelligent cities. An intelligent city is a future city which provides diverse multiple technologies intelligently integrated to provide seamless applications and advanced and intelligent services on various access networks. The objective of intelligent cities is to improve the quality of life in cities and to catalyze economic development by integrating a diversity of services of various sectors such as protection and security, health, education, transport and traffic such as for example intelligent traffic systems and advice for pedestrians or the management of other public services such as water, energy and the environment. The ultimate objective of intelligent cities is to provide a better way of living in the community by making services available to everyone anywhere at any time;
intelligent transport systems are for example systems which may be offered within the framework of an intelligent city. Travellers can employ diverse services installed on their mobile terminals or a composition of remote services before and during their journeys. These services can involve several operators such as banks (for payment for their journeys), railway companies or airlines, operators of travel services, operators of road traffic, operators of metros, buses, trams, airports, taxi companies, the police or fire department and weather services. Travellers can use several types of mobile apparatuses to access these services. Several types of unforeseeable events may arise during their journeys such as accidents which block rail or road traffic or unforeseen weather conditions such as snow. If the travellers' itinerary does not allow them to accomplish their objectives after these events, then new possibilities must be evaluated so as to revise their itinerary. A change of travellers' itinerary can result in a change of the composition of the services that is used;
military tactical situations like those of crises are unforeseeable and dynamic and require a rapid understanding of the battle situation and its consequences. Their management consists in rapidly creating an organization which can control the situation. Technologies make it possible to automatically manage the variability of business processes based on sensors locating for example tanks, boats or combatants and having the capacity to manipulate dynamic situations are therefore extremely useful in this field.
for adaptive systems: these systems are of several types. They may be able to evolve such as a secure information system which can self-adapt so as to decrease risks potentially incurred by the system following an illegal intrusion as they can represent a sub-type of mobile systems such as an application used on various mobile terminals which varies for example as a function of the size of their screens, of their operating systems or of the memory built into them. They can also represent a sub-type of autonomous systems such as an application for supervising network infrastructures.

Advantageously, the system according to the invention allows dynamic adaptation of a complex system as a function of its environment or of a particular event.

The device according to the invention makes it possible to adapt a complex system at the level of its business processes and of its service architecture as a function of dynamic variations in its context and its environment. Thus, variability is taken into account in an automatic manner at several system design levels: from the level of the business processes defined by the operational users of the system, up to the executable system itself, and including the architecture of the system along the way.

Advantageously, the modeling of variability used by the device according to the invention allows the variable process models to be made understandable and modifiable by users who are not specialists in programming. For example business experts can easily upgrade their variable process models by adding or modifying patterns of variability as a function of context. The modifications performed on the system variability model can thus be taken into account automatically to generate a new composition of the system as well as the software code which makes it possible to deploy this new composition of the system.

Advantageously, the architecture proposed by the device according to the invention makes it possible to reason with regard to context information and to automatically determine a business process that best adapts to the context. By virtue of the device according to the invention, dynamic changes of business process may be hot-modified during execution on the architectural layer of the sub-systems making up the complex system, by modifying their assembly as well as their orchestration.

Advantageously, the device according to the invention is accompanied by a methodology which makes it possible to model context-dependent variable business processes. Advantageously the proposed methodology makes it possible to reduce the complexity of the modeling of the business processes and to be able to use the device according to the invention to culminate in the generation of a code which builds the application in such a way that it adapts to the context.

The fact that the invention is based on an approach directed by models makes it possible to generate an executable code which orchestrates the services offered by a system on the basis of a business process. Thus the business processes, the architecture and the code of the sub-systems are placed at the same level with respect to the way in which the variability of the business processes is taken into account. Thus the business-related abstract layer is linked with the technical layers of the sub-systems.

Advantageously, the methodology accompanying the architecture according to the invention defines patterns for modeling the variable business processes on the one hand making it possible to investigate and to analyses the impact of a change of context on a business process and on the other hand to reduce the complexity of the business processes.

Advantageously the variability is managed at an abstract level very close to the end user: that of the business processes. Thus it is much simpler for a user to define his business processes and to control the way in which they are taken into account by the various sub-systems of the complex system.

Advantageously, the device according to the invention makes it possible to manage the variability of the context and the adaptation of the abstraction system and allows the variability and the adaptation of the system to be echoed step by step onto the technical architecture of the lower-level system. Thus, any variation at the strategic and business level may be taken into account with appropriate technical solutions deriving directly from the variations taken into account at high abstraction level. The device according to the invention thus makes it possible to manage the variability and the adaptation at various levels of abstraction. This additionally allows traceability of the variability between the various design levels of systems: from the business process level, to the architectural level and up to the application code. Traceability is ensured by virtue of the automatic transformation of the business processes.

### Annexes

Annexe 1: XML code of a variable business process

```
<?xml version=“1.0” encoding=“UTF-8”?>
@PATTERN= “Variable”
<sub-process name=“Dynamic activation of the sensors”
      xmlns=“http://jbpm.org/4.0/jpdl”>
  <start g= “24,72,80,40”>
  <transition to= “Activate all the mobile cameras”/>
  </start>
  <state= “Activate all the mobile cameras” g= “12,68,38,56”>
  <transition to= “Activate all the smoke detectors”/>
  </state>
  @PATTERN=“Optional”, CONTEXT= “Fire”
  <state name= “Activate all the smoke detectors” g= “143,147,92,52”>
  <transition to=“Activate all the gas detectors” g=“30,18”/>
  </state>
  @PATTERN= “Optional”, CONTEXT= “Explosion”
  <state name=“Activate all the gas detectors” g=“143,147,92,52”>
  <transition to=“end” g=“30,18”/>
  </state>
  <end g=“165,267,80,40” name=“end”/>
</process>
```

Annexe 2: XML code without variability, generated by the reasoner
48 in the case of the “Fire” context

```
<?xml version=“1.0” encoding=“UTF-8”?>
<sub-process  name=“Dynamic  activation  of  the  sensors”
xmlns=“http://jbpm.org/4.0/jpdl”>
  <start g=“24,72,80,40”>
  <transition to=“Activate all the mobile cameras”/>
  </start>
  <state=“Activate all the mobile cameras” g=“12,68,38,56”>
  <transition to=“Activate all the smoke detectors”/>
  </state>
  <state name=“Activate all the smoke detectors” g=“143,147,92,52”>
  <transition to=“end” g=“30,18”/>
  </state>
  <end g=“165,267,80,40” name=“end”/>
</process>
```

Annexe 3: XML code without variability, generated by the reasoner
48 in the case of the “Explosion” context

```
<?xml version=“1.0” encoding=“UTF-8”?>
<sub-process name=“Dynamic activation of the sensors”
xmlns=“http://jbpm.org/4.0/jpdl”>
  <start g=“24,72,80,40”>
  <transition to=“Activate all the mobile cameras”/>
  </start>
  <state=“Activate all the mobile cameras” g=“12,68,38,56”>
  <transition to=“Activate all the gas detectors” g=“30,18”/>
  </state>
  <state name=“Activate all the gas detectors” g=“143,147,92,52”>
  <transition to=“end” g=“30,18”/>
  </state>
  <end g=“165,267,80,40” name=“end”/>
</process>
```

Annexe 4: BPEL code generated by the executable business
process generator 401 and corresponding to the XML code of annexe 2

```
<partnerLinks>
  <partnerLink name=“Airport”
  partnerLinkType=“services:ActivateSensors”/>
</partnerLinks>
<sequence>
  <invoke name=“ActivateMobileCamera” partnerLink=“Airport”
      portType=“services:ActivateSensors” />
  <invoke name=“ActivateFireSensors” partnerLink=“Airport”
      portType=“services:ActivateSensors” />
</sequence>
</process>
```

Annexe 5: BPEL code generated by the executable business
process generator 401 and corresponding to the XML code of annexe 3

```
<process name=“Dynamic activation of the sensors”
  <partnerLinks>
  <partnerLink name=“Airport”
      partnerLinkType=“services:ActivateSensors”/>
  </partnerLinks>
  <sequence>
  <invoke name=“ActivateMobileCamera” partnerLink=“Airport”
      portType=“services:ActivateSensors” />
  <invoke name=“ActivateGasSensors” partnerLink=“Airport”
      portType=“services:ActivateSensors” />
  </sequence>
</process>
```

1. A device for dynamically adapting a complex system to various contexts of use of the complex system, the complex system comprising a set of heterogeneous sub-systems interacting, a context being defined by a set of data characterizing a particular situation to which the complex system is subjected, the device performing an orchestration of the sub-systems by executing business processes adapted automatically by the device to a current context, the device taking as input a variable business process model that can vary as a function of context, a business process being a succession of tasks to be carried out by the sub-systems within the framework of a procedure specific to a technical field, the current context being a set of data characterizing the particular situation at a given instant.

2. The device according to claim 1, comprising a first component performing centralized management of the context data.

3. The device according to claim 1, wherein the current context is a high-level context which comprises an interpretation of a set of data of low-level contexts originating from sensors and from other types of sources, and context collectors.

4. The device according to claim 1, comprising:
a second component taking as input: the context data provided by the first component and the variable business process model, the said second component determining as a function of the current context the tasks making up the business process, generating a business process model adapted to the current context;
a third component taking as input the business process model adapted to the current context so as to generate an executable business process; and
a fourth component using as input an executable business process orchestrating the sub-systems for carrying out the executable business process.

5. The device according to claim 4, wherein the fourth component replaces the business process undergoing execution with a new executable business process upon a change of context.

6. The device according to claim 1, comprising:
a fifth component taking as input the variable business process model, generating an executable variable business process; and
a sixth component taking as input the executable variable business process, the context data provided by the first component, generating a variable business process executable as a function of the current context, resolving the variabilities of the business processes as a function of the current context, orchestrating the sub-systems for carrying out the executable business process.

7. The device according to claim 3, wherein the context sources and sensors are distributed in a theatre of operations.

8. A method for dynamically adapting a complex system to various contexts of use of the complex system, the complex system comprising a set of heterogeneous sub-systems interacting, a context being defined by a set of data characterizing a particular situation to which the complex system is subjected, said method comprising:
generating a business process model adapted to the current context as a function of a variable business process model and of data of the current context;
generating an executable business process on the basis of the business process model adapted to the context; and
orchestrating the sub-systems for carrying out the executable business process.

9. A method for dynamically adapting a complex system to various contexts of use of the complex system, the complex system comprising a set of heterogeneous sub-systems interacting, a context being defined by a set of data characterizing a particular situation to which the complex system is subjected, the method comprising:
generating an executable variable business process as a function of a variable business process model;
orchestrating the sub-systems for carrying out the business process, by taking into account the executable variable business process and the data of current context.
